(19) United States
(12) Patent Application Publication
(10) Pub. No.: US 2022/0393148 A1
(43) Pub. Date: Dec. 8, 2022

(54) NEGATIVE ELECTRODE AND NONAQUEOUS ELECTROLYTE SECONDARY BATTERY INCLUDING THE SAME

(71) Applicant: Prime Planet Energy & Solutions, Inc., Tokyo (JP)

(72) Inventors: Yuki MORIKAWA, Kobe-shi (JP); Akira TSUJIKO, Kobe-shi (JP)

(21) Appl. No.: 17/834,868

(22) Filed: Jun. 7, 2022

(30) Foreign Application Priority Data
Jun. 8, 2021 (JP) 2021-095625

(51) Int. Cl. H01M 4/134; H01M 10/0525

(52) U.S. Cl. CPC H01M 4/134; H01M 10/0525; H01M 2004/027

(57) ABSTRACT

The negative electrode disclosed herein includes: a negative electrode current collector; and a negative electrode active material layer formed on the surface of the negative electrode current collector. The negative electrode active material layer contains silicon oxide containing at least one alkali earth metal. The negative electrode active material layer includes at least a first layer and a second layer. The first layer is disposed between the second layer and the negative electrode current collector. The amount of the alkali earth metal in the second layer calculated based on energy dispersive X-ray spectroscopy using a scanning electron microscope image is higher than the amount of the alkali earth metal in the first layer.

### CROSS REFERENCE TO RELATED APPLICATIONS

The present application is based upon and claims the benefit of priority from Japanese Patent Application No. 2021-095625 filed on Jun. 8, 2021, and the entire disclosure of which is incorporated herein its entirety by reference.

### BACKGROUND

The present disclosure relates to a negative electrode. The present disclosure further relates to a nonaqueous electrolyte secondary battery including the negative electrode.

In recent years, nonaqueous electrolyte secondary batteries such as lithium ion secondary batteries have been suitably used as portable power sources for personal computers, mobile terminals, and the like, and power sources for driving vehicles such as electric vehicles (BEV), hybrid vehicles (HEV), and plug-in hybrid vehicles (PHEV).

The negative electrode of a nonaqueous electrolyte secondary battery is generally configured such that the negative electrode active material layer containing a negative electrode active material is supported on the negative electrode current collector. In recent years, in order to increase the capacity of the negative electrode, it has been considered to use a silicon (Si)-based negative electrode active material such as silicon and a silicon compound, which can store and release chemical species (e.g., lithium ions) to be charge carriers (e.g., Japanese Patent Application Publication No. 2015-18663 and Japanese Patent Application Publication No. 2016-181331).

Further, the following is known. Si-based negative electrode active material described above has a high theoretical capacity, but has a large expansion and contraction (volume change) of the negative electrode active material with a charge-discharge cycle. Thus, the capacity retention rate decreases after the charge-discharge cycle. Japanese Patent Application Publication No. 2018-156922 discloses a silicon composite oxide for use in the negative electrode material, containing a MgSiO₃ crystal and having its surface coated with a carbon substance, and a negative electrode using the oxide. Japanese Patent Application Publication No. 2018-156922 further discloses that this allows improvement in charge-discharge capacity and the initial charge and discharge efficiency of the secondary battery and the capacity retention rate.

### SUMMARY

As a result of earnest study, the present inventors found as follows. The secondary battery using a Si-based negative electrode active material containing a MgSiO₃ crystal improves its capacity retention rate (cycle life) by the charge-discharge cycle, but greatly reduces its capacity retention rate when a rapid charge-discharge cycle is performed.

The present disclosure was made in view of the circumstances described above, and a main objective of the present disclosure is to provide a negative electrode which achieves both improvement in the cycle life of the secondary battery and improvement in capacity retention rate after the rapid charge-discharge cycle. Another objective of the present disclosure is to provide a nonaqueous electrolyte secondary battery including the negative electrode.

The negative electrode disclosed herein includes: a negative electrode current collector; and a negative electrode active material layer formed on a surface of the negative electrode current collector. The negative electrode active material layer includes silicon oxide containing at least one alkali earth metal. The negative electrode active material layer includes at least a first layer and a second layer. The first layer is disposed between the second layer and the negative electrode current collector. And, an amount of the alkali earth metal in the second layer calculated based on energy dispersive X-ray spectroscopy using a scanning electron microscope image is higher than an amount of the alkali earth metal in the first layer.

In this configuration, the silicon oxide containing an alkali earth metal which may contribute to the improvement in cycle life is unevenly distributed in the second layer disposed on the surface layer side of the negative electrode active material layer. This substantially prevents concentration of the reaction only in the vicinity of the surface of the negative electrode active material layer when the rapid charge-discharge cycle is performed. With this configuration, a negative electrode which achieves both improvement in cycle life of the secondary battery and improvement in capacity retention rate after rapid charge-discharge cycle can be provided.

In one aspect of the negative electrode disclosed herein, the second layer contains at least 2 mass % or more of the silicon oxide containing the alkali earth metal, relative to 100 mass % of the negative electrode active material in the second layer. With this configuration, the cycle life of the secondary battery can be further improved.

In one aspect of the negative electrode disclosed herein, the first layer contains less than 2 mass % of the silicon oxide containing the alkali earth metal, relative to 100 mass % of the negative electrode active material in the first layer. With this configuration, a negative electrode more suitably achieving both improvement in cycle life of the secondary battery and improvement in capacity retention rate after rapid charge-discharge cycle can be provided.

In one aspect of the negative electrode disclosed herein, a ratio of an average thickness of the second layer to an average thickness of the negative electrode active material layer is 20% or more to 70% or less. With this configuration, the capacity retention rate after the rapid charge-discharge cycle for the secondary battery can be further improved.

In one aspect of the negative electrode disclosed herein, the silicon oxide containing the alkali earth metal includes silicon oxide containing magnesium and/or silicon oxide containing calcium. With this configuration, a negative electrode more suitably achieving both improvement in cycle life of the secondary battery and improvement in capacity retention rate after rapid charge-discharge cycle can be provided.

In one aspect of the negative electrode disclosed herein, the negative electrode active material layer contains a carbon material. With this configuration, a negative electrode more suitably achieving both improvement in cycle life of the secondary battery and improvement in capacity retention rate after rapid charge-discharge cycle can be provided.

In one aspect of the negative electrode disclosed herein, the first layer further contains silicon oxide containing an alkali metal in addition to the silicon oxide containing the alkali earth metal. In another aspect, the second layer further contains silicon oxide containing an alkali metal in addition to the silicon oxide containing the alkali earth metal. With this configuration, a negative electrode more suitably achieving both improvement in cycle life of the secondary battery and improvement in capacity retention rate after rapid charge-discharge cycle can be provided.

In one aspect of the negative electrode disclosed herein, the silicon oxide containing the alkali metal includes silicon oxide containing lithium. In the configuration, silicon oxide containing an alkali earth metal which suitably improves the cycle life, and silicon oxide containing lithium which has high Li dispersibility are used. Accordingly, the entire negative electrode active material layer can contribute to an efficient cell reaction. This allows more suitable achievement in both improvement in the cycle life of the secondary battery and the improvement in the capacity retention rate after the rapid charge-discharge cycle.

In another aspect, the nonaqueous electrolyte secondary battery disclosed herein includes a positive electrode, the negative electrode, and a nonaqueous electrolyte. With this configuration, a nonaqueous electrolyte secondary battery having an excellent cycle life and an excellent capacity retention rate when the rapid charge-discharge cycle is performed can be provided.

### BRIEF DESCRIPTION OF THE DRAWINGS

FIG. 1 is a schematic explanatory drawing of a structure of a negative electrode according to an embodiment.

FIG. 2 is a schematic section view of a lithium ion secondary battery according to an embodiment.

FIG. 3 is a schematic exploded view of a configuration of a wound electrode assembly of a lithium ion secondary battery according to the embodiment.

### DETAILED DESCRIPTION

An embodiment of the present disclosure will be described below with reference to the accompanying drawings. The matters necessary for executing the present disclosure, which is not mentioned herein, can be grasped as design matters of those skilled in the art based on the related art in the preset field. The present disclosure can be executed based on the contents disclosed herein and the technical knowledge in the present field. In the following drawings, the same members/portions which exhibit the same action are denoted by the same reference numeral. The dimensional relation (such as length, width, or thickness) in each drawing does not reflect the actual dimensional relation.

The “secondary battery” herein indicates an electricity storage device that can be repeatedly charged and discharged, and encompasses so-called secondary batteries and electricity storage elements such as electric double-layer capacitors. The “lithium ion secondary battery” herein indicates a secondary battery which uses lithium ions as electric charge carriers and achieves charging and discharging by movement of electric charges associated with the lithium ions between positive and negative electrodes.

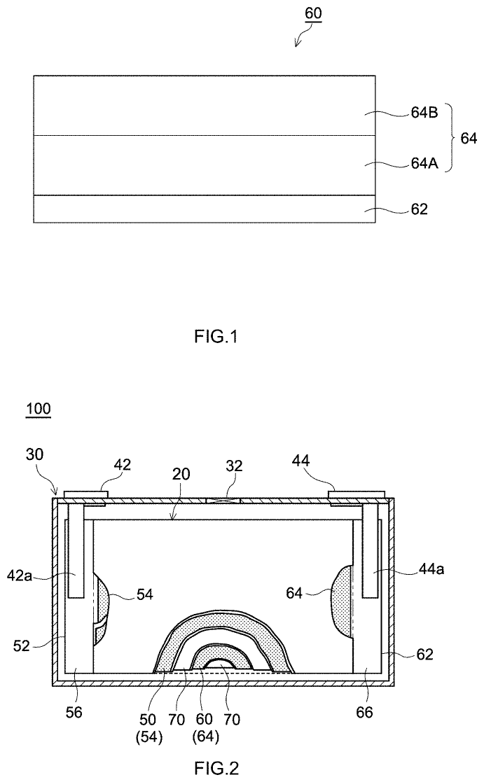

FIG. 1 schematically illustrates the negative electrode disclosed herein. The negative electrode 60 includes, as shown in FIG. 1, a negative electrode current collector 62 and a negative electrode active material layer 64 supported on the negative electrode current collector 62. In the example shown in FIG. 1, the negative electrode active material layer 64 is provided on one surface of the negative electrode current collector 62, but may be provided on each of both surfaces of the negative electrode current collector 62. The negative electrode active material layer 64 is desirably provided on each of both surfaces of the negative electrode current collector 62.

As the negative electrode current collector 62, a sheet or a foil-like body made of a metal such as copper, nickel, titanium, and stainless steel can be used, and a copper foil is suitably used. If a copper foil is used as the negative electrode current collector 62, the thickness thereof is, for example, 5 μm or more to 35 μm or less, desirably 7 μm or more to 20 μm or less although not particularly limited thereto.

As shown in FIG. 1, the negative electrode active material layer 64 at least includes a first layer 64A and a second layer 64B. The first layer 64A is formed between the second layer 64B and the negative electrode current collector 62. The first layer 64A is positioned on the negative electrode current collector 62 side, and the second layer 64B is positioned on the surface layer side of the negative electrode active material layer 64. The first layer 64A is typically formed on the surface of the negative electrode current collector 62. The negative electrode active material layer 64 may have a multilayer structure of at least two layers, and may have a multilayer structure of three or more layers.

The negative electrode active material layer 64 includes silicon oxide containing at least one type of alkali earth metal as a negative electrode active material. The negative electrode 60 disclosed here, the amount of the alkali earth metal in the second layer 64B calculated based on energy dispersive X-ray spectroscopy using a scanning electron microscope image is higher than the amount of the alkali earth metal in the first layer 64A.

The “amount (mass %) of the alkali earth metal” herein can be determined by energy dispersive X-ray spectroscopy (SEM-EDS) using a scanning electron microscope. Specifically, first, a SEM image of the cross section of the negative electrode active material layer along its thickness direction is captured. Then, the SEM image is subjected to EDS to calculate the proportion (mass %) of each constitutional element contained in the negative electrode active material layer. The proportion of the alkali earth metal element (such as Mg and Ca) calculated (i.e., the proportion of the alkali earth metal element relative to all constitutional elements in the negative electrode active material layer) is referred to as the “amount (mass %) of the alkali earth metal” herein.

The amount (mass %) of the alkali earth metal in each of the first layer and the second layer can be calculated as follows, for example. Assume that in the cross section of the negative electrode active material layer along its thickness direction, 20% of the thickness from the current collector toward the internal direction of the active material layer is set as the first layer, and 20% of the thickness from the surface layer toward the internal direction of the active material layer is set as the second layer. Then, in the same manner as described above, the first layer and the second layer are subjected to EDS, and the proportion (mass %) of each constitutional element in each of the first layer and the second layer is calculated. The proportion of the alkali earth metal element in all constitutional elements in the first layer is referred to as “the amount (mass %) of the alkali earth metal in the first layer” herein, and the proportion of the alkali earth metal element in all constituent elements in the second layer is referred to as “the amount of the alkali earth metal in the second layer” herein.

The amount of the alkali earth metal in the second layer 64B is typically desirably 0.5 mass % or more to 10 mass % or less, more desirably 1 mass % or more to 8 mass % or less. The amount of the alkali earth metal in the first layer 64A may be less than 2 mass %, or 1 mass % or less. Typically, a region containing 0.5 mass % or more alkali earth metal calculated by SEM-EDS is set as the second layer 64B. The amount of the alkali earth metal in the first layer 64A does not limit the technology disclosed herein. In other words, the amount of the alkali earth metal in the first layer 64A may be 0 mass %. If the amount of the alkali earth metal in each of the first layer 64A and the second layer 64B is within the above range, an effect of improving the cycle life of the secondary battery and the effect of improving the capacity retention rate after the rapid charge-discharge cycle can be both suitably achieved.

The average thickness of the negative electrode active material layer 64 may be, for example, 10 pin or more to 300 μm or less, or 20 μm or more to 200 μm or less. In one aspect, a ratio of the average thickness of the second layer 64B to the average thickness of the negative electrode active material layer 64 is desirably 15% to 75%, more desirably 20% to 70%.

The negative electrode active material layer 64 at least contains a negative electrode active material which can reversibly store and release a chemical species that serve as charge carriers (lithium ions in the lithium ion secondary battery). In the technology disclosed herein, the negative electrode active material layer 64 contains silicon oxide containing at least one alkali earth metal as a negative electrode active material. The silicon oxide containing an alkali earth metal is typically in the state where silicon oxide (SiO_{y}) containing silicon (Si) and oxygen (O) as a necessary component is doped with the alkali earth metal (such as Mg and Ca). For example, the silicon oxide desirably has composition represented by the general formula: MₓSiO_{y} (where x and y satisfy 0<x≤0.25 and 0<y≤2, respectively. M is at least one element selected from the group consisting of Mg, Ca, Be, Sr, Ba, and Ra). Among them, the silicon oxide containing an alkali earth metal is desirably silicon oxide containing Mg and/or silicon oxide containing Ca.

The mean particle diameter (median diameter D50) of the silicon oxide containing an alkali earth metal is, although not particularly limited thereto, for example, 0.5 μm or more to 15 μm or less. The “mean particle diameter (median diameter DSO)” herein is a particle diameter corresponding to the particle diameter at a cumulative value of 50% of fine particle side in the volume-based particle size distribution based on commonly used laser diffraction/scattering method.

The silicon oxide containing Mg is typically a compound of Mg−Si—O, which is silicon oxide (SiO_{y}) doped with Mg as an alkali earth metal. When SiO_{y} is doped with Mg, a Si phase, a SiO_{y} phase, or a MgSiO₃ phase may be generated as a crystal structure. The silicon oxide containing Mg typically has a MgSiO₃ phase. In the technology disclosed herein, the silicon oxide containing Mg desirably has composition represented by the general formula: Mg_{α}SiO_{y} (where β and y satisfy 0<α≤0.25 and 0<y≤2, respectively).

Similarly, the silicon oxide containing Ca is typically a compound of Ca—Si—O, which is silicon oxide (SiO_{y}) doped with Ca as an alkali earth metal. In the technology disclosed herein, the silicon oxide containing Ca desirably has composition represented by the general formula: CaoSiO_{y} (where β and y satisfy 0<β≤0.25 and 0<y≤2, respectively).

The mass proportion of the silicon oxide containing the alkali earth metal in the second layer 64B is desirably 1 mass % to 20 mass %, more desirably 1.5 mass % to 20 mass %, particularly desirably 2 mass % to 20 mass %, relative to 100 mass % of the negative electrode active material in the second layer 64B. The mass proportion of the silicon oxide containing the alkali earth metal in the first layer 64A is desirably less than 2 mass %, more desirably 1.5 mass % or less, particularly desirably 1 mass % or less, relative to 100 mass % of the negative electrode active material in the first layer 64A. Whether the first layer 64A contains silicon oxide containing an alkali earth metal does not limit the technology disclosed herein. That is, the mass proportion of the silicon oxide containing the alkali earth metal in the first layer 64A may be 0 mass %.

The mass proportion of the silicon oxide containing the alkali earth metal in each layer can be determined by setting the first and second layers as mentioned above and subjecting the first and second layers to ICP spectroscopy, for example.

When the silicon oxide containing an alkali earth metal is unevenly dispersed in the second layer, an effect of improving the cycle life of the secondary battery and the effect of improving the capacity retention rate after the rapid charge-discharge cycle can be both suitably achieved. The reason for this is not particularly limited, but it is assumed that the above-mentioned effects can be obtained for the following reasons.

When the silicon oxide contains an alkali earth metal by doping or the like, chemical species which serve as charge carriers (lithium ions in the lithium ion secondary battery) tend to be dispersed slowly. If the negative electrode active material layer is made of only silicon oxide containing an alkali earth metal, the capacity retention rate after the cycle is improved, but excessive lithium that cannot be dispersed fully is deposited at the time when the rapid charging and discharging are repeated, and the capacity retention rate after the rapid charge-discharge cycle decreases. In contrast, in the technology disclosed herein, the silicon oxide containing an alkali earth metal is unevenly dispersed in the second layer which is on the surface layer side of the negative electrode active material layer. As a result, lithium ions are dispersed more suitably on the current collector side than on the surface layer side. Accordingly, the entire negative electrode active material layer can contribute to efficient charging and discharging, whereby improvement in the cycle life of the secondary battery and the improvement in the capacity retention rate when the rapid charge-discharge cycle is performed can be both achieved.

The silicon oxide containing an alkali earth metal may be produced by the following method, for example. First, a powder of SiO_{y} and a raw material powder of an alkali earth metal (e.g., Mg or Ca) are provided. The raw material powder of the alkali earth metal may be, for example, a Mg powder or a Ca powder. The powder of SiO_{y} and the raw material powder of the alkali earth metal are mixed using a ball mill or the like to obtain a powder mixture. The powder mixture is heated at about 1000° C. for about 1 hour in an argon (Ar) atmosphere. Thus, SiO_{y} is doped with the alkali earth metal.

The negative electrode active material layer 64 further contains, as a negative electrode active material, a carbon material such as graphite, hard carbon, and soft carbon in addition to the silicon oxide containing an alkali earth metal. The graphite may be natural graphite, artificial graphite, or amorphous carbon-coated graphite where graphite is coated with an amorphous carbon material.

Properties (e.g., the average particle diameter and the BET specific surface area) of the carbon material are not particularly limited. The carbon material is typically granule. The mean particle diameter D50 of the particulate carbon material is typically 1 μm or more to 20 μm or less, for example, 5 μm or more to 15 μm or less. The carbon material having a BET specific surface area measured by the BET method of typically 0.5 cm²/g or more to 3 cm²/g or less can be desirably employed.

The negative electrode active material layer 64 may further contain silicon oxide containing an alkali metal in addition to the above-mentioned materials. The silicon oxide containing an alkali metal is typically in the state where silicon oxide (SiO_{y}) containing silicon (Si) and oxygen (O) as necessary components is doped with the alkali metal (such as Li and Na). For example, the silicon oxide containing an alkali metal desirably has composition represented by the general formula: Q_{y}SiO_{y} (where γ and y satisfy 0<y≤2 and 0<y≤2, respectively. Q is at least one element selected from the group consisting of Li, Na, Km Rb, Cs, and Fr). Among them, the silicon oxide containing an alkali metal is desirably silicon oxide containing Li.

The silicon oxide containing an alkali metal can be produced in the same manner as for the silicon oxide containing an alkali earth metal.

The mass proportion of silicon oxide containing the alkali metal in the first layer 64A may be 18 mass % or less, 9 mass % or less, or 8 mass % or less, relative to 100 mass % of the negative electrode active material in the first layer 64A. The mass proportion of silicon oxide containing the alkali metal in the second layer 64B may be 20 mass % or less, 18 mass % or less, or 16 mass % or less, relative to 100 mass % of the negative electrode active material in the second layer 64B. In the technology disclosed herein, the mass proportion of the silicon oxide containing the alkali metal in the first layer 64A and the second layer 64B (in other words, the negative electrode active material layer 64) does not limit the technology disclosed herein. That is, the mass proportion of the silicon oxide containing the alkali metal in the negative electrode active material layer 64 may be 0 mass %.

The mass proportion of the silicon oxide containing the alkali metal in each layer can be determined by subjecting the layer to ICP spectroscopy, for example.

The negative electrode active material layer 64 may contain another negative electrode active material within a range which does not inhibit the effect of the technology disclosed therein, in addition to the materials described above. The other negative electrode active material can be, for example, an Si-based negative electrode active material. Examples of the Si-based negative electrode active material include an elemental metal of Si, an oxide (e.g., SiO_{y}) of Si as a constitutional element, and an alloy of Si as a constitutional element.

Although not particularly limited thereto, the content of the negative electrode active material in the negative electrode active material layer 64 (i.e., the proportion of the negative electrode active material in the total mass of the negative electrode active material layer) may be 80 mass % to 99 mass %, or 85 mass % to 98 mass %. The mass proportion of the Si-based negative electrode active material (including silicon oxide containing an alkali earth metal and silicon oxide containing an alkali metal) is desirably 1 mass % to 30 mass %, more desirably 2 mass % to 30 mass %, relative to 100 mass % of the negative electrode active material in the negative electrode active material layer 64. The mass proportion of the carbon material is desirably 70 mass % to 99 mass %, more desirably 80 mass % to 98 mass %, relative to 100 mass % of the negative electrode active material in the negative electrode active material layer 64.

Although not particularly limited thereto, the content of the negative electrode active material in the first layer 64A may be 80 mass % to 99 mass %, or 85 mas % to 98 mass %. The mass proportion of the Si-based negative electrode active material (including silicon oxide containing an alkali earth metal and silicon oxide containing an alkali metal) may be typically 0 mass % to 20 mass %, 0 mass % to 10 mass %, or 1 mass % to 10 mass %, relative to 100 mass % of the negative electrode active material in the first layer 64A. The mass proportion of the carbon material may be typically 80 mass % to 100 mass %, 90 mass % to 100 mass %, or 90 mass % to 99 mass %, relative to 100 mass % of the negative electrode active material in the first layer 64A.

Although not particularly limited thereto, the content of the negative electrode active material in the second layer 64B may be 80 mass % to 99 mass %, or 85 mas % to 98 mass %. The mass proportion of the Si-based negative electrode active material (including silicon oxide containing an alkali earth metal and silicon oxide containing an alkali metal) is desirably 1 mass % to 20 mass %, more desirably 2 mass % to 20 mass %, relative to 100 mass % of the negative electrode active material in the second layer 64B. The mass proportion of the carbon material is desirably 80 mass % to 99 mass %, more desirably 80 mass % to 98 mass %, relative to 100 mass % of the negative electrode active material in the second layer 64B.

The negative electrode active material layer 64 may further contain, for example, a component other than the negative electrode active material, such as a binder and a thickener. As the binder, a styrene-butadiene rubber (SBR) and a modified product thereof, acrylonitrile butadiene rubber and a modified product thereof, an acrylic rubber and a modified product thereof, and a fluorine rubber may be used, for example. Among them, the binder is desirably SBR. The content of the binder in the negative electrode active material layer 64 is desirably 0.1 mass % or more to 8 mass % or less, more desirably 0.2 mas % or more to 3 mass % or less although not particularly limited thereto.

Examples of the thickener used include: cellulose-based polymers such as carboxymethyl cellulose (CMC), methyl cellulose (MC), cellulose acetate phthalate (CAP), and hydroxypropyl methylcellulose (HPMC); and polyvinyl alcohol (PVA). Among them, the thickener is desirably CMC. The content of the thickener in the negative electrode active material layer 64 is desirably 0.3 mass % or more to 3 mass % or less, more desirably 0.4 mas % or more to 2 mass % or less although not particularly limited thereto.

According to the negative electrode configured as described above, improvement in the cycle life of the secondary battery and improvement in the capacity retention rate when the rapid charge-discharge cycle is performed are both achieved. The negative electrode configured as described above can be used as a negative electrode for a secondary battery in accordance with a known method. Thus, the negative electrode disclosed herein is suitably for use in a secondary battery. The secondary battery is suitably a nonaqueous electrolyte secondary battery.

### <Nonaqueous Electrolyte Secondary Battery>

In another aspect, the nonaqueous electrolyte secondary battery disclosed herein includes the negative electrode, a positive electrode, and a nonaqueous electrolyte.

An embodiment of the nonaqueous electrolyte secondary battery disclosed herein will be described in detail below with reference to a flat square lithium ion secondary battery including a flat wound electrode assembly and a flat battery case as an example. However, this is not intended to limit the nonaqueous electrolyte secondary battery disclosed herein to the one described in the embodiment.

The lithium ion secondary battery 100 shown in FIG. 2 is a sealed battery constructed by housing a flat wound electrode assembly 20 and a nonaqueous electrolyte (not shown) in a flat square battery case (i.e., an outer container) 30. The battery case 30 includes a positive electrode terminal 42 and negative electrode terminal 44 for external connection, and a thin-walled safety valve 32 set to release an internal pressure of the battery case 30 when the internal pressure increases to a predetermined level or higher. The battery case 30 is provided with an inlet (not shown) for introducing the nonaqueous electrolyte. The positive electrode terminal 42 is electrically connected to a positive electrode current collector 42a. The negative electrode terminal 44 is electrically connected to a negative electrode current collector 44a. As the material of the battery case 30, a metal material which is light and has high thermal conductivity, such as aluminum can be used, for example.

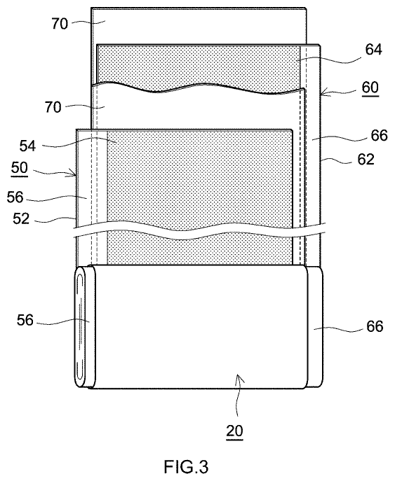

As shown in FIGS. 2 and 3, the wound electrode assembly 20 has a form in which a positive electrode sheet 50 and a negative electrode sheet 60 are overlaid on each other via two long separators 70 and are wound in the longitudinal direction. The positive electrode sheet 50 has a configuration where a positive electrode active material layer 54 is formed on one or both surfaces (here, on both surfaces) of a long positive electrode current collector 52 along the longitudinal direction. The negative electrode sheet 60 has a configuration where a negative electrode active material layer 64 is formed on one or both surfaces (here, on both surfaces) of a long negative electrode current collector 62 along the longitudinal direction. A positive electrode active material layer non-formation portion 56 (i.e., exposed portion of the positive electrode collector 52 at which the positive electrode active material layer 54 is not formed) and a negative electrode active material layer non-formation portion 66 (i.e. exposed portion of the negative electrode collector 62 at which the negative electrode active material layer 64 is not formed) are formed so as to extend off outwardly from both ends in the winding axial direction (i.e., the sheet width direction orthogonal to the longitudinal direction) of the wound electrode body 20, respectively. The positive electrode active material layer non-formation portion 56 and the negative electrode active material layer non-formation portion 66 are joined to a positive electrode current collector 42a and a negative electrode current collector 44a, respectively.

As the negative electrode sheet 60, the above-mentioned negative electrode is used.

As the positive electrode current collector 52 forming the positive electrode sheet 50, a sheet or a foil-like body made of a metal such as aluminum, nickel, titanium, and stainless steel can be used, and an aluminum foil is suitably used. If an aluminum foil is used as the positive electrode current collector 52, the thickness thereof is, for example, 5 μm or more to 35 μm or less, desirably 7 μm or more to 20 μm or less.

The positive electrode active material contained in the positive electrode active material layer 54 is not particularly limited as the positive electrode active material, and one kind, or two or more kinds of commonly used positive electrode active materials for nonaqueous electrolyte secondary batteries, particularly lithium ion secondary batteries can be used. The positive electrode active material used can be desirably, for example, a lithium composite oxide, or a lithium transition metal phosphate compound (e.g., LiFePO₄). Examples of the lithium composite oxide include a lithium nickel-based composite oxide, lithium cobalt-based composite oxide, a lithium manganese-based composite oxide, a lithium nickel manganese-based composite oxide (e.g., LiNi_{0.5}Mn_{1.5}O₄), and a lithium nickel manganese cobalt-based composite oxide (e.g., LiNi_{1/3}Co_{1/3}Mn_{1/3}O₂).

The mean particle diameter of the positive electrode active material is approximately 0.5 μm or more to 50 μm or less, typically 1 μm or more to 20 μm or less although not particularly limited thereto.

The positive electrode active material layer 54 may further contain, for example, an electroconductive material, a binder, and the like besides the positive electrode active material. The electroconductive material used can be, for example, desirably carbon black such as acetylene black (AB) and other carbon materials (such as graphite). The binder used can be, for example, desirably fluorine-based binders such as polyvinylidene fluoride (PVdF) and polytetrafluoroethylene (PTFE) and rubber-based binders such as styrene-butadiene rubber (SBR). The positive electrode active material layer 54 may further contain, for example, materials (e.g., various additives) in addition to the above-mentioned materials as long as it does not impair the effect of the present disclosure.

In light of the energy density, the content of the positive electrode active material in the positive electrode active material layer 54 (i.e., the proportion of the positive electrode active material in the total mass of the positive electrode active material layer) is desirably approximately 70 mass % or more. The content of the positive electrode active material is, for example, more desirably 75 mass % to 99 mass %, yet more desirably 80 mass % to 97 mass %. The content of the electroconductive material in the positive electrode active material layer 54 is, for example, desirably 0.1 mass % to 20 mass %, more desirably 1 mass % to 15 mass %. The content of the binder in the positive electrode active material layer 54 is, for example, desirably 0.5 mass % to 15 mass %, more desirably 1 mass % to 10 mass %. If the positive electrode active material layer 54 contains various additives such as a thickener, the content of the additives in the positive electrode active material layer 54 is, for example, desirably 7 mass % or less, more desirably 5 mass % or less.

Examples of the separator 70 include porous sheets (films) made of resin such as polyethylene (PE), polypropylene (PP), polyester, cellulose, and polyamide. Such a porous sheet may have a monolayer structure, or a lamination structure of two or more layers (e.g., a three-layer structure where PP layers are stacked on both surfaces of a PE layer). The surface of the separator 70 may be provided with a heat-resistant layer (HRL).

Although not particularly limited thereto, the thickness of the separator 70 is, for example, 5 μm or more to 50 μm or less, desirably 10 μm or more to 30 μm or less.

The nonaqueous electrolyte used is typically a liquid (nonaqueous electrolyte) obtained by dissolving or dispersing an electrolyte salt (in other words, a supporting electrolyte) in a nonaqueous solvent. Alternatively, the nonaqueous electrolyte may be a solid (typically a so-called gel) obtained by adding a polymer to the nonaqueous electrolyte. The nonaqueous solvent used can be any of organic solvents such as various carbonates, ethers, esters, nitriles, sulfones, and lactones, which are used in an electrolyte of commonly used lithium ion secondary batteries, without particular limitations. Among them, the nonaqueous solvent used is desirably carbonates, and specific examples thereof include ethylene carbonate (EC), propylene carbonate (PC), diethyl carbonate (DEC), dimethyl carbonate (DMC), ethyl methyl carbonate (EMC), monofluoro ethylene carbonate (MFEC), difluoro ethylene carbonate (DFEC), monofluoromethyl difluoromethyl carbonate (F-DMC), and trifluorodimethyl carbonate (TFDMC). These nonaqueous solvents may be used alone or in combination of two or more of them, as appropriate.

The electrolyte salt used can be, for example, a lithium salt such as LiPF₆, LiBF₄, or lithium bis(fluorosulfonyl)imide (LiFSI), and is desirably LiPF₆ among them. The concentration of the electrolyte salt is not particularly limited, and is desirably 0.7 mol/L or more to 1.3 mol/L or less. The nonaqueous electrolyte may further contain, for example, various additives such as a film-forming agent, namely an oxalato complex; gas generating agent, namely biphenyl (BP) and cyclohexyl benzene (CHB); and a thickener, in addition to the components mentioned above, as long as the effect of the present disclosure is not significantly impaired.

The lithium ion secondary battery 100 configured as described above achieves both improvement in the cycle life and improvement in the capacity retention rate after the rapid charge-discharge cycle. The lithium ion secondary battery 100 can be used for various applications. Suitable applications include power sources for driving, to be mounted on vehicles such as electric vehicles (BEV), hybrid vehicles (HEV), and plug-in hybrid vehicles (PHEV). Among them, power sources for driving, to be mounted on electric vehicles (BEV) are, for example, required to be charged (rapidly charged) in a short time and is rapidly discharged frequently at the time of vehicle acceleration and the like. Thus, the negative electrode disclosed herein and the secondary battery including the negative electrode are more suitably applied thereto. Typically, the multiple lithium ion secondary batteries 100 used may be connected in series and/or parallel to be in an assembled battery.

The square lithium ion secondary battery 100 including the flat wound electrode assembly 20 has been described above as an example. However, the lithium ion secondary battery disclosed herein can be configured as a lithium ion secondary battery including a laminated electrode assembly (i.e., an electrode assembly where multiple positive electrodes and multiple negative electrodes are stacked alternately). the nonaqueous electrolyte secondary battery disclosed herein may also be configured as a cylindrical lithium ion secondary battery, a laminate case type lithium ion secondary battery, or coin type lithium ion secondary battery, for example.

In accordance with a known method, the negative electrode may be used to construct an all-solid-state battery including a solid electrolyte layer and a gel electrolyte instead of the nonaqueous electrolyte and the separator, a sodium ion secondary battery, and other secondary batteries.

Some test examples regarding the present disclosure will be described below. However, it is not intended that the present disclosure is limited to such test examples.

### Example 1

In ion-exchange water, 100 parts by mass of graphite (C) as a negative electrode active material, 1 part by mass of styrene-butadiene rubber (SBR) as a binder, and 1 part by mass of carboxymethyl cellulose (CMC) as a thickener were mixed. Thus, a first negative electrode mixture slurry was prepared.

Further, as negative electrode active materials, 10 parts by mass of silicon oxide containing magnesium (Mg) and 90 parts by mass of graphite (C) were mixed. Thus, a negative electrode active material mixture of the silicon oxide containing Mg and the graphite was produced. In ion-exchange water, 100 parts by mass of the negative electrode active material mixture, 1 part by mass of styrene-butadiene rubber (SBR) as a binder, and 1 part by mass of carboxymethyl cellulose (CMC) as a thickener were mixed. Thus, a second negative electrode mixture slurry was prepared.

The first negative electrode mixture slurry was applied to both surfaces of a negative electrode current collector made of a copper foil and then dried. The resultant coating film was then extended by pressurization using a roller. Subsequently, the second negative electrode mixture slurry was applied to the dried coating film of the first negative electrode mixture slurry, and dried and extended by pressurization in the same manner as described above. Thus, a negative electrode sheet of Example 1 in which a negative electrode active material layer including a first layer made of the first negative electrode mixture slurry and a second layer made of the second negative electrode mixture slurry was supported on the negative electrode current collector was obtained. The second negative electrode mixture slurry was applied so that the average thickness of the negative electrode active material layer reached 50% of the average thickness of the second layer.

LiN_{1/3}Co_{1/3}Mn_{1/3}O₂ (NCM1) as a positive electrode active material, acetylene black (AB) as an electroconductive material, and polyvinylidene fluoride (PVdF) as a binder were mixed at a mass ratio of NCM:AB:PVdF=97:2:1 in N-methylpyrrolidone (NMP). Thus, a positive electrode mixture slurry was prepared. The positive electrode mixture slurry was applied to an aluminum foil. Then, the resultant coating film was roll-pressed to have a predetermined thickness. Thus, a positive electrode sheet was produced.

As a separator, a porous polyolefin sheet having a three-layer structure of PP/PE/PE was provided. The positive electrode sheet and the negative electrode sheet were overlaid with the separator interposed therebetween, and wound to obtain a wound body. The wound body was pressed to produce a flat wound electrode assembly.

An electrode terminal was attached to the electrode assembly, which was then inserted into a case made of an aluminum laminate film and welded. Then, a nonaqueous electrolyte was introduced into the case. As the nonaqueous electrolyte, one obtained by dissolving LiPF₆ at a concentration of 1.0 mol/L in a solvent mixture containing ethylene carbonate (EC), dimethyl carbonate (DMC), and ethyl methyl carbonate (EMC) at a volume ratio of 3:4:3. Thereafter, the laminate case was sealed. Thus, a lithium ion secondary battery of Example 1 for evaluation was obtained.

### Examples 2 and 3

Lithium ion secondary batteries of Examples 2 and 3 for evaluation were produced in the same manner as in Example 1 except that the mass proportion (mass %) of the silicon oxide containing Mg in the second layer was changed as shown in Table 1.

### Example 4

As negative electrode active materials, 10 parts by mass of silicon oxide containing Mg and 90 parts by mass of graphite (C) were mixed. Thus, a negative electrode active material mixture of the silicon oxide containing Mg and the graphite was produced. In ion-exchange water, 100 parts by mass of the negative electrode active material mixture, 1 part by mass of styrene-butadiene rubber (SBR) as a binder, and 1 part by mass of carboxymethyl cellulose (CMC) as a thickener were mixed. Thus, a first negative electrode mixture slurry was prepared. Then, a lithium ion secondary battery of Example 4 for evaluation was produced in the same manner as in Example 1 except for the first negative electrode mixture slurry.

### Examples 5 to 7

As negative electrode active materials, 10 parts by mass of silicon oxide containing lithium (Li) and 90 parts by mass of graphite (C) were mixed. Thus, a negative electrode active material mixture of the silicon oxide containing Li and the graphite was produced. In ion-exchange water, 100 parts by mass of the negative electrode active material mixture, 1 part by mass of styrene-butadiene rubber (SBR) as a binder, and 1 part by mass of carboxymethyl cellulose (CMC) as a thickener were mixed. Thus, a first negative electrode mixture slurry was prepared. Further, the mass proportion (mass % of the silicon oxide containing Mg in the second layer was changed as shown in Table 1. Lithium ion secondary batteries of Examples 5 to 7 for evaluation were produced in the same manner as in Example 1 except for this.

### Examples 8 and 9

Lithium ion secondary batteries of Examples 8 and 9 for evaluation were produced in the same manner as in Example 1 except that the mass proportions (mass %) of the silicon oxide containing Mg and the silicon oxide containing Li in the first layer were changed as shown in Table 1.

### Examples 10 to 12

Lithium ion secondary batteries of Examples 10 to 12 for evaluation were produced in the same manner as in Example 6 except that the second negative electrode mixture slurry was applied so that the ratio of the average thickness of the second layer to the average thickness of the negative electrode active material layer reached a value shown in Table 1.

<Activation of Lithium Ion Secondary Battery for Evaluation>

The produced lithium ion secondary batteries of Examples 1 to 12 for evaluation were placed in an environment at 25° C. For activation (initial charging), as the constant current constant voltage method, each lithium ion secondary battery for evaluation was subjected to constant current charging to 4.1 V at a current value of 1/3C and then subjected to constant voltage charging until the current value reached 1/50C. Thus, the lithium ion secondary battery was fully charged. Thereafter, the lithium ion secondary battery for evaluation was subjected to constant current discharging to 3.0 V at a current value of 1/3C.

<Charge-Discharge Cycle Test>

The activated lithium ion secondary battery for evaluation was placed in an environment at 25° C. Then, charging and discharging of performing constant current charging to 4.1 V at a current value of 0.5C and constant current discharging to 3.0 V at a current value of 0.5C as one cycle was repeated for 500 cycles. The discharge capacities of the 1st and 500th cycles were measured, and the ratio of the discharge capacity of the 500th cycle to the discharge capacity of the 1st cycle was calculated as the capacity retention rate (%). The capacity retention rate after 500 cycles of 90% or more was evaluated as “A”; that of 80% or more to less than 90% was evaluated as “B”; and that of less than 80% was evaluated as “C.” The results are shown in Table 1. If the capacity retention rate after the 500 cycles is good, the cycle life of the secondary battery can be evaluated as high.

<Rapid Charge-Discharge Cycle Test>

The activated lithium ion secondary battery for evaluation was placed in an environment at 25° C. Then, charging and discharging of performing constant current charging to 4.1 V at a current value of 2C and constant current discharging to 3.0 V at a current value of 2C as one cycle was repeated for 100 cycles. The discharge capacities of the 1st and 100th cycles were measured, and the ratio of the discharge capacity of the 100th cycle to the discharge capacity of the 1st cycle was calculated as the capacity retention rate (%). The capacity retention rate after the rapid charge-discharge cycles of 90% or more was evaluated as “A”; that of 80% or more to less than 90% was evaluated as “B”; and that of less than 80% was evaluated as “C.” The results are shown in Table 1.

TABLE 1

| | Second Layer | | | First Layer | | | | |
|---|---|---|---|---|---|---|---|---|
| | Mass | Mass | | Mass | Mass | | | Capacity |
| | Proportion | Proportion | | Proportion | Proportion | | | Retention |
| | (mass %) | (mass %) | | (mass %) | (mass %) | | Capacity | Rate |
| | of | of | | of | of | | Retention | after |
| | Silicon | Silicon | | Silicon | Silicon | | Rate | Rapid |
| | Oxide | Oxide | | Oxide | Oxide | | after | Charge- |
| | containing | containing | Thickness | containing | containing | Thickness | 500 | Discharge |
| | Mg | Li | (%) | Mg | Li | (%) | Cycles | Cycle |
| Ex. 1 | 10 | 0 | 50 | 0 | 0 | 50 | A | A |
| Ex. 2 | 20 | 0 | 50 | 0 | 0 | 50 | A | A |
| Ex. 3 | 2 | 0 | 50 | 0 | 0 | 50 | A | A |
| Ex. 4 | 10 | 0 | 50 | 10 | 0 | 50 | A | C |
| Ex. 5 | 20 | 0 | 50 | 0 | 10 | 50 | A | A |
| Ex. 6 | 10 | 0 | 50 | 0 | 10 | 50 | A | A |
| Ex. 7 | 2 | 0 | 50 | 0 | 10 | 50 | A | A |
| Ex. 8 | 10 | 0 | 50 | 1 | 9 | 50 | A | A |
| Ex. 9 | 10 | 0 | 50 | 2 | 8 | 50 | A | B |
| Ex. 10 | 10 | 0 | 20 | 0 | 10 | 80 | A | A |
| Ex. 11 | 10 | 0 | 70 | 0 | 10 | 30 | A | A |
| Ex. 12 | 10 | 0 | 80 | 0 | 10 | 20 | A | B |

As can be seen from Table 1, when the negative electrode active material layer contains silicon oxide containing at least one alkali earth metal, and the amount of the alkali earth metal in the second layer is higher than the amount of the alkali earth metal in the first layer, the capacity retention rates after the 500 cycles and the rapid charge-discharge cycle are 80% or more. On the other hand, as can be seen from the result of Example 4, when the amounts of the alkali earth metal in the first and second layers are the same, the capacity retention rate after the rapid charge-discharge cycle is less than 80%.

As can be seen from the result of Example 3, when at least 2 mass % or more of the silicon oxide containing an alkali earth metal is contained relative to 100 mass % of the negative electrode active materials in the second layer, the capacity retention rates after the 500 cycles and the rapid charge-discharge cycle were both 90% or more.

As can be seen from the result of Example 8, when less than 2 mass % silicon oxide containing an alkali earth metal is contained relative to 100 mass % of the negative electrode active materials in the first layer, the capacity retention rates after the 500 cycles and the rapid charge-discharge cycle are both 90% or more.

As can be seen from the results of Examples 10 and 11, when the ratio of the average thickness of the second layer to the average thickness of the negative electrode active material layer is 20% or more to 70% or less, the capacity retention rates after the 500 cycles and the rapid charge-discharge cycle are both 90% or more.

### Example 13

As negative electrode active materials, 1 part by mass of silicon oxide containing Mg, 9 parts by mass of silicon oxide containing Li, and 90 parts by mass of graphite (C) were mixed. Thus, a negative electrode active material mixture of the silicon oxide containing Mg, the silicon oxide containing Li, and the graphite was produced. In ion-exchange water, 100 parts by mass of the negative electrode active material mixture, 1 part by mass of styrene-butadiene rubber (SBR) as a binder, and 1 part by mass of carboxymethyl cellulose (CMC) as a thickener were mixed. Thus, a first negative electrode mixture slurry was prepared.

As negative electrode active materials, 2 part by mass of silicon oxide containing Mg, 8 parts by mass of silicon oxide containing Li, and 90 parts by mass of graphite (C) were mixed. Thus, a negative electrode active material mixture of the silicon oxide containing Mg, the silicon oxide containing Li, and the graphite was produced. In ion-exchange water, 100 parts by mass of the negative electrode active material mixture, 1 part by mass of styrene-butadiene rubber (SBR) as a binder, and 1 part by mass of carboxymethyl cellulose (CMC) as a thickener were mixed. Thus, a second negative electrode mixture slurry was prepared.

The first negative electrode mixture slurry and the second negative electrode mixture slurry were applied to the negative electrode current collector, in the same manner as described above, dried, and pressed. Thus, a negative electrode sheet of Example 13 was produced.

A lithium ion secondary battery of Example 13 for evaluation was produced in the same manner as in Example 1 except for this.

### Examples 14 and 15

Lithium ion secondary batteries of Examples 14 and 15 for evaluation were produced in the same manner as in Example 13 except that the mass proportions (mass %) of the silicon oxide containing Mg and the silicon oxide containing Li contained in the first and second layers were changed as shown in Table 2.

### Example 16

As negative electrode active materials, 10 parts by mass of silicon oxide containing Mg and 90 parts by mass of graphite (C) were mixed. Thus, a negative electrode active material mixture of the silicon oxide containing Mg and the graphite was produced. In ion-exchange water, 100 parts by mass of the negative electrode active material mixture, 1 part by mass of styrene-butadiene rubber (SBR) as a binder, and 1 part by mass of carboxymethyl cellulose (CMC) as a thickener were mixed. Thus, a first negative electrode mixture slurry was prepared.

As negative electrode active materials, 10 parts by mass of silicon oxide containing Li and 90 parts by mass of graphite (C) were mixed. Thus, a negative electrode active material mixture of the silicon oxide containing Li and the graphite was produced. In ion-exchange water, 100 parts by mass of the negative electrode active material mixture, 1 part by mass of styrene-butadiene rubber (SBR) as a binder, and 1 part by mass of carboxymethyl cellulose (CMC) as a thickener were mixed. Thus, a second negative electrode mixture slurry was prepared. A lithium ion secondary battery of Examples 16 for evaluation was produced in the same manner as in Example 1 except for this.

### Reference Example

As a reference example, a negative electrode active material layer which contains no silicon oxide containing Mg was formed. Specifically, as negative electrode active materials, 10 parts by mass of silicon oxide containing Li and 90 parts by mass of graphite (C) were mixed. Thus, a negative electrode active material mixture of the silicon oxide containing Li and the graphite was produced. In ion-exchange water, 100 parts by mass of the negative electrode active material mixture, 1 part by mass of styrene-butadiene rubber (SBR) as a binder, and 1 part by mass of carboxymethyl cellulose (CMC) as a thickener were mixed. Thus, first and second negative electrode mixture slurries were prepared. A lithium ion secondary battery of Reference Example for evaluation was produced in the same manner as in Example 1 except for this.

The produced lithium ion secondary batteries of Examples 13 to 16 and Reference Example for evaluation were activated (initial-charged) in the same manner as mentioned above. The activated lithium ion secondary batteries for evaluation were subjected to the charge-discharge cycle and the rapid charge-discharge cycle test in the same manner as mentioned above. The capacity retention rates after the 500 cycles and the rapid charge-discharge cycles of both 90% or more were evaluated as “A”; those of both 80% or more to less than 90% were evaluated as “B”; and those of less than 80% were evaluated as “C.” The results are shown in Table 2.

TABLE 2

| | Second Layer | | | First Layer | | | | |
|---|---|---|---|---|---|---|---|---|
| | Mass | Mass | | Mass | Mass | | | Capacity |
| | Proportion | Proportion | | Proportion | Proportion | | | Retention |
| | (mass %) | (mass %) | | (mass %) | (mass %) | | Capacity | Rate |
| | of | of | | of | of | | Retention | after |
| | Silicon | Silicon | | Silicon | Silicon | | Rate | Rapid |
| | Oxide | Oxide | | Oxide | Oxide | | after | Charge- |
| | containing | containing | Thickness | containing | containing | Thickness | 500 | Discharge |
| | Mg | Li | (%) | Mg | Li | (%) | Cycles | Cycle |
| Ex. 13 | 2 | 8 | 50 | 1 | 9 | 50 | A | A |
| Ex. 14 | 1 | 9 | 50 | 2 | 8 | 50 | B | B |
| Ex. 15 | 1 | 9 | 50 | 0 | 10 | 50 | B | A |
| Ex. 16 | 0 | 10 | 50 | 10 | 0 | 50 | A | B |
| Ref. Ex. | 0 | 10 | 50 | 0 | 10 | 50 | C | B |

As can be seen from Table 2, even if the second layer contains the silicon oxide containing Li, but the amount of the alkali earth metal in the second layer is higher than that in the first layer, and the second layer contains 2 mass % or more of silicon oxide containing an alkali earth metal relative to 100 mass % of the negative electrode active material in the second layer the capacity retention rates after the 500 cycles and the rapid charge-discharge cycle are both 90% or more, and the cycle life of the secondary battery and the rapid charge-discharge cycle characteristics are particularly high.

### Example 21

10 parts by mass of silicon oxide containing Li and 90 parts by mass of graphite (C) were mixed. Thus, a negative electrode active material mixture of the silicon oxide containing Li and the graphite was produced. In ion-exchange water, 100 parts by mass of the negative electrode active material mixture, 1 part by mass of styrene-butadiene rubber (SBR) as a binder, and 1 part by mass of carboxymethyl cellulose (CMC) as a thickener were mixed. Thus, a first negative electrode mixture slurry was prepared.

20 parts by mass of silicon oxide containing Ca and 80 parts by mass of graphite (C) were mixed. Thus, a negative electrode active material mixture of the silicon oxide containing Ca and the graphite was produced. In ion-exchange water, 100 parts by mass of the negative electrode active material mixture, 1 part by mass of styrene-butadiene rubber (SBR) as a binder, and 1 part by mass of carboxymethyl cellulose (CMC) as a thickener were mixed. Thus, a second negative electrode mixture slurry was prepared.

The first negative electrode mixture slurry was applied to both surfaces of a negative electrode current collector made of a copper foil and then dried. The resultant coating film was then extended by pressurization using a roller. Subsequently, the second negative electrode mixture slurry was applied to the dried coating film of the first negative electrode mixture slurry, in the same manner as described above, dried, and pressed by a rolling roller. Thus, a negative electrode sheet of Example 21 in which the negative electrode active material layer including a first layer made of the first negative electrode mixture slurry and a second layer made of the second negative electrode mixture slurry was supported on the negative electrode current collector was obtained. The second negative electrode mixture slurry was applied so that the ratio of the average thickness of the second layer to the average thickness of the negative electrode active material layer reached 50%.

A lithium ion secondary battery of Example 21 for evaluation was produced in the same manner as in Example 1 except for the negative electrode sheet.

### Examples 22 and 23

Lithium ion secondary batteries of Examples 22 and 23 for evaluation were produced in the same manner as in Example 1 except that the mass proportion (mass %) of the silicon oxide containing Ca in the second layer was changed as shown in Table 3.

### Example 24

As negative electrode active materials, 10 parts by mass of silicon oxide containing Ca and 90 parts by mass of graphite (C) were mixed. Thus, a negative electrode active material mixture of the silicon oxide containing Mg and the graphite was produced. In ion-exchange water, 100 parts by mass of the negative electrode active material mixture, 1 part by mass of styrene-butadiene rubber (SBR) as a binder, and 1 part by mass of carboxymethyl cellulose (CMC) as a thickener were mixed. Thus, a first negative electrode mixture slurry was prepared.

As negative electrode active materials, 10 parts by mass of silicon oxide containing Li and 90 parts by mass of graphite (C) were mixed. Thus, a negative electrode active material mixture of the silicon oxide containing Li and the graphite was produced. In ion-exchange water, 100 parts by mass of the negative electrode active material mixture, 1 part by mass of styrene-butadiene rubber (SBR) as a binder, and 1 part by mass of carboxymethyl cellulose (CMC) as a thickener were mixed. Thus, a second negative electrode mixture slurry was prepared. A lithium ion secondary battery of Examples 24 for evaluation was produced in the same manner as in Example 1 except for this.

The produced lithium ion secondary batteries of Examples 21 to 24 and Reference Example for evaluation were activated (initial-charged) in the same manner as mentioned above. Each activated lithium ion secondary battery for evaluation was subjected to the charge-discharge cycle test and the rapid charge-discharge cycle test in the same manner as mentioned above. If the capacity retention rates after the 500 cycles and the rapid charge-discharge cycles are 90% or more, it is evaluated as “A”; if they are between 80% or more to less than 90%, it is evaluated as “B”; and if they are less than 80%, it is evaluated as “C.” The results are shown in Table 3.

TABLE 3

| | Second Layer | | | First Layer | | | | |
|---|---|---|---|---|---|---|---|---|
| | Mass | Mass | | Mass | Mass | | | Capacity |
| | Proportion | Proportion | | Proportion | Proportion | | | Retention |
| | (mass %) | (mass %) | | (mass %) | (mass %) | | Capacity | Rate |
| | of | of | | of | of | | Retention | after |
| | Silicon | Silicon | | Silicon | Silicon | | Rate | Rapid |
| | Oxide | Oxide | | Oxide | Oxide | | after | Charge- |
| | containing | containing | Thickness | containing | containing | Thickness | 500 | Discharge |
| | Mg | Li | (%) | Mg | Li | (%) | Cycles | Cycle |
| Ex. 21 | 20 | 0 | 50 | 0 | 10 | 50 | A | A |
| Ex. 22 | 10 | 0 | 50 | 0 | 10 | 50 | A | A |
| Ex. 23 | 2 | 0 | 50 | 0 | 10 | 50 | A | A |
| Ex. 24 | 0 | 10 | 50 | 10 | 0 | 50 | A | B |

As can be seen from Table 3, even when the type of the silicon oxide containing an alkali earth metal is changed, the same tendency as in Examples 5 to 7 shown in Table 1 was shown. Accordingly, regardless of the type of the silicon oxide containing an alkali earth metal, it is possible to provide a secondary battery negative electrode with excellent cycle life and excellent capacity retention rate after the rapid charge-discharge cycle.

Although specific examples of the present disclosure have been described in detail above, they are mere examples and do not limit the appended claims. The technology described in the appended claims include various modifications and changes of the foregoing specific examples.

What is claimed is:

1. A secondary battery negative electrode comprising:
a negative electrode current collector; and
a negative electrode active material layer formed on a surface of the negative electrode current collector, wherein
the negative electrode active material layer contains silicon oxide containing at least one alkali earth metal,
the negative electrode active material layer includes at least a first layer and a second layer,
the first layer is disposed between the second layer and the negative electrode current collector, and
an amount of the alkali earth metal in the second layer calculated based on energy dispersive X-ray spectroscopy using a scanning electron microscope image is higher than an amount of the alkali earth metal in the first layer.

2. The secondary battery negative electrode according to claim 1, wherein
the second layer contains at least 2 mass % or more of the silicon oxide containing the alkali earth metal, relative to 100 mass % of the negative electrode active material in the second layer.

3. The secondary battery negative electrode according to claim 1, wherein
the first layer contains less than 2 mass % of the silicon oxide containing the alkali earth metal, relative to 100 mass % of the negative electrode active material in the first layer.

4. The secondary battery negative electrode according to claim 1, wherein
a ratio of an average thickness of the second layer to an average thickness of the negative electrode active material layer is 20% or more to 70% or less.

5. The secondary battery negative electrode according to claim 1, wherein
the silicon oxide containing the alkali earth metal includes silicon oxide containing magnesium and/or silicon oxide containing calcium.

6. The secondary battery negative electrode according to claim 1, wherein
the negative electrode active material layer contains a carbon material.

7. The secondary battery negative electrode according to claim 1, wherein
the first layer further contains silicon oxide containing an alkali metal in addition to the silicon oxide containing the alkali earth metal.

8. The secondary battery negative electrode according to claim 1, wherein
the second layer further contains silicon oxide containing an alkali metal in addition to the silicon oxide containing the alkali earth metal.

9. The secondary battery negative electrode according to claim 7, wherein
the silicon oxide containing the alkali metal includes silicon oxide containing lithium.

10. A nonaqueous electrolyte secondary battery comprising:
the negative electrode according to claim 1;
a positive electrode; and
a nonaqueous electrolyte.
